(19) United States
(12) Patent Application Publication
(10) Pub. No.: US 2024/0039672 A1
(43) Pub. Date: Feb. 1, 2024

(54) TECHNIQUES FOR UPLINK TRANSMISSION SWITCHING WITH SOUNDING REFERENCE SIGNAL CARRIER SWITCHING

(71) Applicant: QUALCOMM Incorporated, San Diego, CA (US)

(72) Inventors: Peter GAAL, San Diego, CA (US); Yiqing CAO, Beijing (CN); Alberto RICO ALVARINO, San Diego, CA (US); Yan LI, Beijing (CN); Kazuki TAKEDA, Minato-ku (JP)

(21) Appl. No.: 18/258,106

(22) PCT Filed: Feb. 19, 2021
(86) PCT No.: PCT/CN2021/076813

§ 371 Date: Jun. 16, 2023

(51) Int. Cl. H04L 5/00; H04W 72/21; H04L 5/14

(52) U.S. Cl. CPC H04L 5/0051; H04W 72/21; H04L 5/1469

(57) ABSTRACT

Various aspects of the present disclosure generally relate to wireless communication. In some aspects, a user equipment (UE) may receive an indication for a reference signal to be transmitted on a first carrier, wherein the UE is configured for reference signal carrier switching between the first carrier and a second carrier associated with uplink data channel or control channel transmission. The UE may receive an indication for uplink transmission switching between the second carrier and a third carrier. The UE may transmit, or suspend transmission, on the third carrier during a time associated with transmission of the reference signal on the first carrier based at least in part on the UE being configured for reference signal carrier switching and uplink transmission switching. Numerous other aspects are described.

### FIELD OF THE DISCLOSURE

Aspects of the present disclosure generally relate to wireless communication and to techniques and apparatuses for uplink transmission switching with sounding reference signal carrier switching.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving an indication for a reference signal to be transmitted on a first carrier, wherein the UE is configured for reference signal carrier switching between the first carrier and a second carrier associated with uplink data channel or control channel transmission; receiving an indication for uplink transmission switching between the second carrier and a third carrier; and transmitting, or suspending transmission, on the third carrier during a time associated with transmission of the reference signal on the first carrier based at least in part on the UE being configured for reference signal carrier switching and uplink transmission switching.

In some aspects, transmitting or suspending transmission on the third carrier is based at least in part on an antenna port capability of the UE.

In some aspects, transmitting or suspending transmission on the third carrier further comprises suspending transmission on the third carrier based at least in part on a sum of a first number of scheduled antenna ports on the third carrier and a second number of configured reference signal antenna ports exceeding the antenna port capability.

In some aspects, transmitting or suspending transmission on the third carrier further comprises temporarily suspending transmission on the third carrier during the time associated with transmission of the reference signal on the first carrier based at least in part on the UE being configured for reference signal carrier switching and uplink transmission switching.

In some aspects, transmitting or suspending transmission on the third carrier further comprises suspending transmission on the third carrier during the time associated with transmission of the reference signal on the first carrier based at least in part on configuration information indicating that the UE is to suspend transmission on the third carrier during the time associated with transmission of the reference signal on the first carrier.

In some aspects, the configuration information is based at least in part on a capability indicating that the UE is associated with a switched uplink.

In some aspects, transmitting or suspending transmission on the third carrier further comprises suspending transmission on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In some aspects, transmitting or suspending transmission on the third carrier further comprises transmitting on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In some aspects, transmitting or suspending transmission on the third carrier further comprises suspending transmission on the third carrier during the time associated with transmission of the reference signal on the first carrier based at least in part on a capability indicating that the UE is associated with a switched uplink.

In some aspects, transmitting or suspending transmission on the third carrier further comprises transmitting on the third carrier during the time associated with transmission of the reference signal on the first carrier based at least in part on a capability indicating that the UE is associated with a dual uplink.

In some aspects, the first carrier is a time division duplexing carrier configured with DL and UL slots but without an uplink data channel or control channel transmission.

In some aspects, the reference signal is a sounding reference signal (SRS) and the time associated with transmission of the reference signal includes at least one of: an SRS transmission time, or a radio frequency retuning time.

In some aspects, a method of wireless communication performed by a base station includes triggering a UE to transmit a reference signal on a first carrier, wherein the UE is configured for reference signal carrier switching between the first carrier and a second carrier associated with uplink data channel or control channel transmission, and wherein the UE is configured for uplink transmission switching between the second carrier and a third carrier; and communicating, or suspending communication, on the third carrier with regard to the UE during a time associated with transmission of the reference signal on the first carrier based at least in part on the UE being configured for reference signal carrier switching and uplink transmission switching.

In some aspects, communicating or suspending communication on the third carrier is based at least in part on an antenna port capability of the UE.

In some aspects, communicating or suspending communication on the third carrier further comprises: suspending communication on the third carrier based at least in part on a sum of a first number of scheduled antenna ports on the third carrier and a second number of configured reference signal antenna ports exceeding the antenna port capability.

In some aspects, communicating or suspending communication on the third carrier further comprises: temporarily suspending communication on the third carrier during the time associated with transmission of the reference signal on the first carrier based at least in part on the UE being configured for reference signal carrier switching and uplink transmission switching.

In some aspects, communicating or suspending communication on the third carrier further comprises: suspending communication on the third carrier during the time associated with transmission of the reference signal on the first carrier based at least in part on configuration information indicating that the UE is to suspend transmission on the third carrier during the time associated with transmission of the reference signal on the first carrier.

In some aspects, the configuration information is based at least in part on a capability indicating that the UE is associated with a switched uplink.

In some aspects, communicating or suspending communication on the third carrier further comprises: suspending communication on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In some aspects, communicating or suspending communication on the third carrier further comprises: communicating on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In some aspects, communicating or suspending communication on the third carrier further comprises: suspending communication on the third carrier during the time associated with transmission of the reference signal on the first carrier based at least in part on a capability indicating that the UE is associated with a switched uplink.

In some aspects, communicating or suspending communication on the third carrier further comprises: communicating on the third carrier during the time associated with transmission of the reference signal on the first carrier based at least in part on a capability indicating that the UE is associated with a dual uplink.

In some aspects, the first carrier is a time division duplexing carrier configured without an uplink data channel or control channel transmission.

In some aspects, the reference signal is an SRS and the time associated with transmission of the reference signal includes at least one of: an SRS transmission time, or a radio frequency retuning time.

In some aspects, a UE for wireless communication includes a memory; and one or more processors operatively coupled to the memory, the memory and the one or more processors configured to: receive an indication for a reference signal to be transmitted on a first carrier, wherein the UE is configured for reference signal carrier switching between the first carrier and a second carrier associated with uplink data channel or control channel transmission; receive an indication for uplink transmission switching between the second carrier and a third carrier; and transmit, or suspend transmission, on the third carrier during a time associated with transmission of the reference signal on the first carrier based at least in part on the UE being configured for reference signal carrier switching and uplink transmission switching.

In some aspects, transmitting or suspending transmission on the third carrier is based at least in part on an antenna port capability of the UE.

In some aspects, the one or more processors, when transmitting or suspending transmission on the third carrier, are configured to: suspend transmission on the third carrier based at least in part on a sum of a first number of scheduled antenna ports on the third carrier and a second number of configured reference signal antenna ports exceeding the antenna port capability.

In some aspects, the one or more processors, when transmitting or suspending transmission on the third carrier, are configured to: temporarily suspend transmission on the third carrier during the time associated with transmission of the reference signal on the first carrier based at least in part on the UE being configured for reference signal carrier switching and uplink transmission switching.

In some aspects, the one or more processors, when transmitting or suspending transmission on the third carrier, are configured to: suspend transmission on the third carrier during the time associated with transmission of the reference signal on the first carrier based at least in part on configuration information indicating that the UE is to suspend transmission on the third carrier during the time associated with transmission of the reference signal on the first carrier.

In some aspects, the configuration information is based at least in part on a capability indicating that the UE is associated with a switched uplink.

In some aspects, the one or more processors, when transmitting or suspending transmission on the third carrier, are configured to: suspend transmission on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In some aspects, the one or more processors, when transmitting or suspending transmission on the third carrier, are configured to: transmit on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In some aspects, the one or more processors, when transmitting or suspending transmission on the third carrier, are configured to: suspend transmission on the third carrier during the time associated with transmission of the reference signal on the first carrier based at least in part on a capability indicating that the UE is associated with a switched uplink.

In some aspects, the one or more processors, when transmitting or suspending transmission on the third carrier, are configured to: transmit on the third carrier during the time associated with transmission of the reference signal on the first carrier based at least in part on a capability indicating that the UE is associated with a dual uplink.

In some aspects, the first carrier is a time division duplexing carrier configured with DL and UL slots but without an uplink data channel or control channel transmission.

In some aspects, the reference signal is a sounding reference signal (SRS) and the time associated with transmission of the reference signal includes at least one of: an SRS transmission time, or a radio frequency retuning time.

In some aspects, a base station for wireless communication includes a memory and one or more processors operatively coupled to the memory, the memory and the one or more processors configured to: trigger a UE to transmit a reference signal on a first carrier, wherein the UE is configured for reference signal carrier switching between the first carrier and a second carrier associated with uplink data channel or control channel transmission, and wherein the UE is configured for uplink transmission switching between the second carrier and a third carrier; and communicate, or suspend communication, on the third carrier with regard to the UE during a time associated with transmission of the reference signal on the first carrier based at least in part on the UE being configured for reference signal carrier switching and uplink transmission switching.

In some aspects, communicating or suspending communication on the third carrier is based at least in part on an antenna port capability of the UE.

In some aspects, the one or more processors, when communicating or suspending communication on the third carrier, are configured to suspend communication on the third carrier based at least in part on a sum of a first number of scheduled antenna ports on the third carrier and a second number of configured reference signal antenna ports exceeding the antenna port capability.

In some aspects, the one or more processors, when communicating or suspending communication on the third carrier, are configured to temporarily suspend communication on the third carrier during the time associated with transmission of the reference signal on the first carrier based at least in part on the UE being configured for reference signal carrier switching and uplink transmission switching.

In some aspects, the one or more processors, when communicating or suspending communication on the third carrier, are configured to suspend communication on the third carrier during the time associated with transmission of the reference signal on the first carrier based at least in part on configuration information indicating that the UE is to suspend transmission on the third carrier during the time associated with transmission of the reference signal on the first carrier.

In some aspects, the configuration information is based at least in part on a capability indicating that the UE is associated with a switched uplink.

In some aspects, the one or more processors, when communicating or suspending communication on the third carrier, are configured to suspend communication on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In some aspects, the one or more processors, when communicating or suspending communication on the third carrier, are configured to communicate on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In some aspects, the one or more processors, when communicating or suspending communication on the third carrier, are configured to suspend communication on the third carrier during the time associated with transmission of the reference signal on the first carrier based at least in part on a capability indicating that the UE is associated with a switched uplink.

In some aspects, the one or more processors, when communicating or suspending communication on the third carrier, are configured to communicate on the third carrier during the time associated with transmission of the reference signal on the first carrier based at least in part on a capability indicating that the UE is associated with a dual uplink.

In some aspects, the first carrier is a time division duplexing carrier configured without an uplink data channel or control channel transmission.

In some aspects, the reference signal is an SRS and the time associated with transmission of the reference signal includes at least one of: an SRS transmission time, or a radio frequency retuning time.

In some aspects, a non-transitory computer-readable medium storing a set of instructions for wireless communication includes one or more instructions that, when executed by one or more processors of a UE, cause the UE to: receive an indication for a reference signal to be transmitted on a first carrier, wherein the UE is configured for reference signal carrier switching between the first carrier and a second carrier associated with uplink data channel or control channel transmission; receive an indication for uplink transmission switching between the second carrier and a third carrier; and transmit, or suspend transmission, on the third carrier during a time associated with transmission of the reference signal on the first carrier based at least in part on the UE being configured for reference signal carrier switching and uplink transmission switching.

In some aspects, transmitting or suspending transmission on the third carrier is based at least in part on an antenna port capability of the UE.

In some aspects, the one or more instructions, that cause the UE to transmit or suspending transmission on the third carrier, cause the UE to suspend transmission on the third carrier based at least in part on a sum of a first number of scheduled antenna ports on the third carrier and a second number of configured reference signal antenna ports exceeding the antenna port capability.

In some aspects, the one or more instructions, that cause the UE to transmit or suspending transmission on the third carrier, cause the UE to temporarily suspend transmission on the third carrier during the time associated with transmission of the reference signal on the first carrier based at least in part on the UE being configured for reference signal carrier switching and uplink transmission switching.

In some aspects, the one or more instructions, that cause the UE to transmit or suspending transmission on the third carrier, cause the UE to suspend transmission on the third carrier during the time associated with transmission of the reference signal on the first carrier based at least in part on configuration information indicating that the UE is to suspend transmission on the third carrier during the time associated with transmission of the reference signal on the first carrier.

In some aspects, the configuration information is based at least in part on a capability indicating that the UE is associated with a switched uplink.

In some aspects, the one or more instructions, that cause the UE to transmit or suspending transmission on the third carrier, cause the UE to suspend transmission on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In some aspects, the one or more instructions, that cause the UE to transmit or suspending transmission on the third carrier, cause the UE to transmit on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In some aspects, the one or more instructions, that cause the UE to transmit or suspending transmission on the third carrier, cause the UE to suspend transmission on the third carrier during the time associated with transmission of the reference signal on the first carrier based at least in part on a capability indicating that the UE is associated with a switched uplink.

In some aspects, the one or more instructions, that cause the UE to transmit or suspending transmission on the third carrier, cause the UE to transmit on the third carrier during the time associated with transmission of the reference signal on the first carrier based at least in part on a capability indicating that the UE is associated with a dual uplink.

In some aspects, the first carrier is a time division duplexing carrier configured with DL and UL slots but without an uplink data channel or control channel transmission.

In some aspects, the reference signal is an SRS and the time associated with transmission of the reference signal includes at least one of: an SRS transmission time, or a radio frequency retuning time.

In some aspects, a non-transitory computer-readable medium storing a set of instructions for wireless communication includes one or more instructions that, when executed by one or more processors of a base station, cause the base station to: trigger a UE to transmit a reference signal on a first carrier, wherein the UE is configured for reference signal carrier switching between the first carrier and a second carrier associated with uplink data channel or control channel transmission, and wherein the UE is configured for uplink transmission switching between the second carrier and a third carrier; and communicate, or suspend communication, on the third carrier with regard to the UE during a time associated with transmission of the reference signal on the first carrier based at least in part on the UE being configured for reference signal carrier switching and uplink transmission switching.

In some aspects, communicating or suspending communication on the third carrier is based at least in part on an antenna port capability of the UE.

In some aspects, the one or more instructions, that cause the base station to communicate or suspend communication on the third carrier, cause the base station to suspend communication on the third carrier based at least in part on a sum of a first number of scheduled antenna ports on the third carrier and a second number of configured reference signal antenna ports exceeding the antenna port capability.

In some aspects, the one or more instructions, that cause the base station to communicate or suspend communication on the third carrier, cause the base station to temporarily suspend communication on the third carrier during the time associated with transmission of the reference signal on the first carrier based at least in part on the UE being configured for reference signal carrier switching and uplink transmission switching.

In some aspects, the one or more instructions, that cause the base station to communicate or suspend communication on the third carrier, cause the base station to suspend communication on the third carrier during the time associated with transmission of the reference signal on the first carrier based at least in part on configuration information indicating that the UE is to suspend transmission on the third carrier during the time associated with transmission of the reference signal on the first carrier.

In some aspects, the configuration information is based at least in part on a capability indicating that the UE is associated with a switched uplink.

In some aspects, the one or more instructions, that cause the base station to communicate or suspend communication on the third carrier, cause the base station to suspend communication on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In some aspects, the one or more instructions, that cause the base station to communicate or suspend communication on the third carrier, cause the base station to communicate on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In some aspects, the one or more instructions, that cause the base station to communicate or suspend communication on the third carrier, cause the base station to suspend communication on the third carrier during the time associated with transmission of the reference signal on the first carrier based at least in part on a capability indicating that the UE is associated with a switched uplink.

In some aspects, the one or more instructions, that cause the base station to communicate or suspend communication on the third carrier, cause the base station to communicate on the third carrier during the time associated with transmission of the reference signal on the first carrier based at least in part on a capability indicating that the UE is associated with a dual uplink.

In some aspects, the first carrier is a time division duplexing carrier configured without an uplink data channel or control channel transmission.

In some aspects, the reference signal is an SRS and the time associated with transmission of the reference signal includes at least one of: an SRS transmission time, or a radio frequency retuning time.

In some aspects, an apparatus for wireless communication includes means for receiving an indication for a reference signal to be transmitted on a first carrier, wherein the apparatus is configured for reference signal carrier switching between the first carrier and a second carrier associated with uplink data channel or control channel transmission; means for receiving an indication for uplink transmission switching between the second carrier and a third carrier; and means for transmitting, or suspending transmission, on the third carrier during a time associated with transmission of the reference signal on the first carrier based at least in part on the apparatus being configured for reference signal carrier switching and uplink transmission switching.

In some aspects, transmitting or suspending transmission on the third carrier is based at least in part on an antenna port capability of the apparatus.

In some aspects, the means for transmitting or suspending transmission on the third carrier further comprises means for suspending transmission on the third carrier based at least in part on a sum of a first number of scheduled antenna ports on the third carrier and a second number of configured reference signal antenna ports exceeding the antenna port capability.

In some aspects, the means for transmitting or suspending transmission on the third carrier further comprises means for temporarily suspending transmission on the third carrier during the time associated with transmission of the reference signal on the first carrier based at least in part on the apparatus being configured for reference signal carrier switching and uplink transmission switching.

In some aspects, the means for transmitting or suspending transmission on the third carrier further comprises means for suspending transmission on the third carrier during the time associated with transmission of the reference signal on the first carrier based at least in part on configuration information indicating that the apparatus is to suspend transmission on the third carrier during the time associated with transmission of the reference signal on the first carrier.

In some aspects, the configuration information is based at least in part on a capability indicating that the apparatus is associated with a switched uplink.

In some aspects, the means for transmitting or suspending transmission on the third carrier further comprises means for suspending transmission on the third carrier during the time associated with transmission of the reference signal on the first carrier based at least in part on configuration information indicating that the apparatus is to suspend transmission on the third carrier, wherein the configuration information is based at least in part on a capability indicating that the apparatus is associated with a dual uplink.

In some aspects, the means for transmitting or suspending transmission on the third carrier further comprises means for transmitting on the third carrier during the time associated with transmission of the reference signal on the first carrier based at least in part on configuration information indicating that the apparatus is to transmit on the third carrier, wherein the configuration information is based at least in part on a capability indicating that the apparatus is associated with a dual uplink.

In some aspects, the means for transmitting or suspending transmission on the third carrier further comprises means for suspending transmission on the third carrier during the time associated with transmission of the reference signal on the first carrier based at least in part on a capability indicating that the apparatus is associated with a switched uplink.

In some aspects, the means for transmitting or suspending transmission on the third carrier further comprises means for transmitting on the third carrier during the time associated with transmission of the reference signal on the first carrier based at least in part on a capability indicating that the apparatus is associated with a dual uplink.

In some aspects, the first carrier is a time division duplexing carrier configured with DL and UL slots but without an uplink data channel or control channel transmission.

In some aspects, the reference signal is an SRS and the time associated with transmission of the reference signal includes at least one of: an SRS transmission time, or a radio frequency retuning time.

In some aspects, an apparatus for wireless communication includes means for triggering a UE to transmit a reference signal on a first carrier, wherein the UE is configured for reference signal carrier switching between the first carrier and a second carrier associated with uplink data channel or control channel transmission, and wherein the UE is configured for uplink transmission switching between the second carrier and a third carrier; and means for communicating, or suspending communication, on the third carrier with regard to the UE during a time associated with transmission of the reference signal on the first carrier based at least in part on the UE being configured for reference signal carrier switching and uplink transmission switching.

In some aspects, communicating or suspending communication on the third carrier is based at least in part on an antenna port capability of the UE.

In some aspects, the means for communicating or suspending communication on the third carrier further comprises means for suspending communication on the third carrier based at least in part on a sum of a first number of scheduled antenna ports on the third carrier and a second number of configured reference signal antenna ports exceeding the antenna port capability.

In some aspects, the means for communicating or suspending communication on the third carrier further comprises means for temporarily suspending communication on the third carrier during the time associated with transmission of the reference signal on the first carrier based at least in part on the UE being configured for reference signal carrier switching and uplink transmission switching.

In some aspects, the means for communicating or suspending communication on the third carrier further comprises means for suspending communication on the third carrier during the time associated with transmission of the reference signal on the first carrier based at least in part on configuration information indicating that the UE is to suspend transmission on the third carrier during the time associated with transmission of the reference signal on the first carrier.

In some aspects, the configuration information is based at least in part on a capability indicating that the UE is associated with a switched uplink.

In some aspects, the means for communicating or suspending communication on the third carrier further comprises means for suspending communication on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In some aspects, the means for communicating or suspending communication on the third carrier further comprises means for communicating on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In some aspects, the means for communicating or suspending communication on the third carrier further comprises means for suspending communication on the third carrier during the time associated with transmission of the reference signal on the first carrier based at least in part on a capability indicating that the UE is associated with a switched uplink.

In some aspects, the means for communicating or suspending communication on the third carrier further comprises means for communicating on the third carrier during the time associated with transmission of the reference signal on the first carrier based at least in part on a capability indicating that the UE is associated with a dual uplink.

In some aspects, the first carrier is a time division duplexing carrier configured without an uplink data channel or control channel transmission.

In some aspects, the reference signal is an SRS and the time associated with transmission of the reference signal includes at least one of: an SRS transmission time, or a radio frequency retuning time.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating examples 300 of carrier aggregation (CA), in accordance with the present disclosure.

FIG. 4 is a diagram illustrating an example of an uplink transmission switching configuration for a CA configuration of a UE, in accordance with the present disclosure.

FIG. 5 is a diagram illustrating an example of a CA configuration for a UE associated with an uplink transmission switching configuration and a sounding reference signal (SRS) carrier switching configuration, in accordance with the present disclosure.

FIG. 6 is a diagram illustrating an example of signaling associated with communication using an uplink transmission switching configuration and an SRS carrier switching configuration, in accordance with the present disclosure.

FIG. 7 is a diagram illustrating an example of signaling associated with communication using an uplink transmission switching configuration and an SRS carrier switching configuration, in accordance with the present disclosure.

FIG. 8 is a diagram illustrating an example process performed, for example, by a UE, in accordance with the present disclosure.

FIG. 9 is a diagram illustrating an example process performed, for example, by a base station, in accordance with the present disclosure.

FIGS. 10 and 11 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

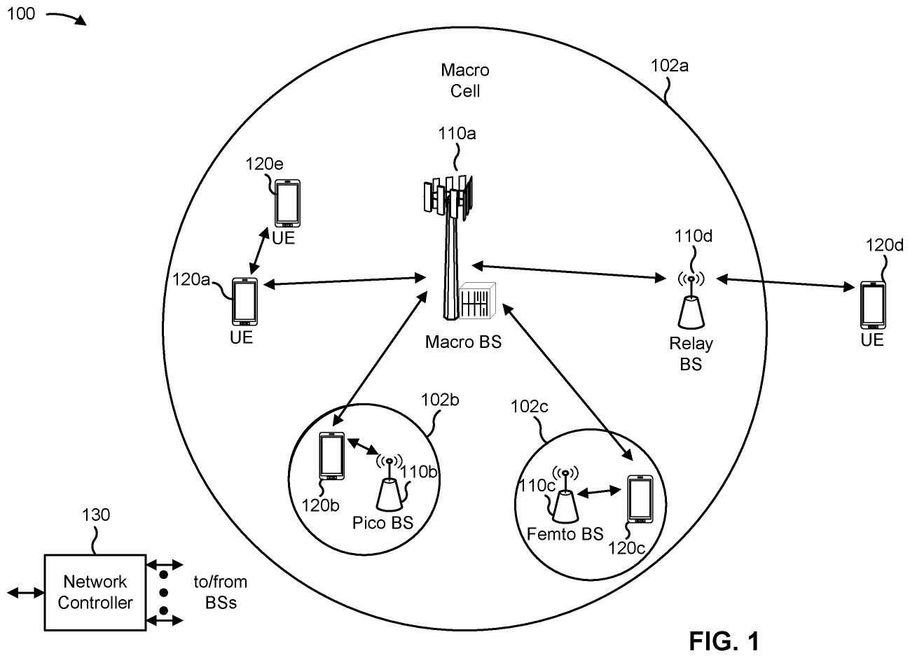

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “A”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UEL) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

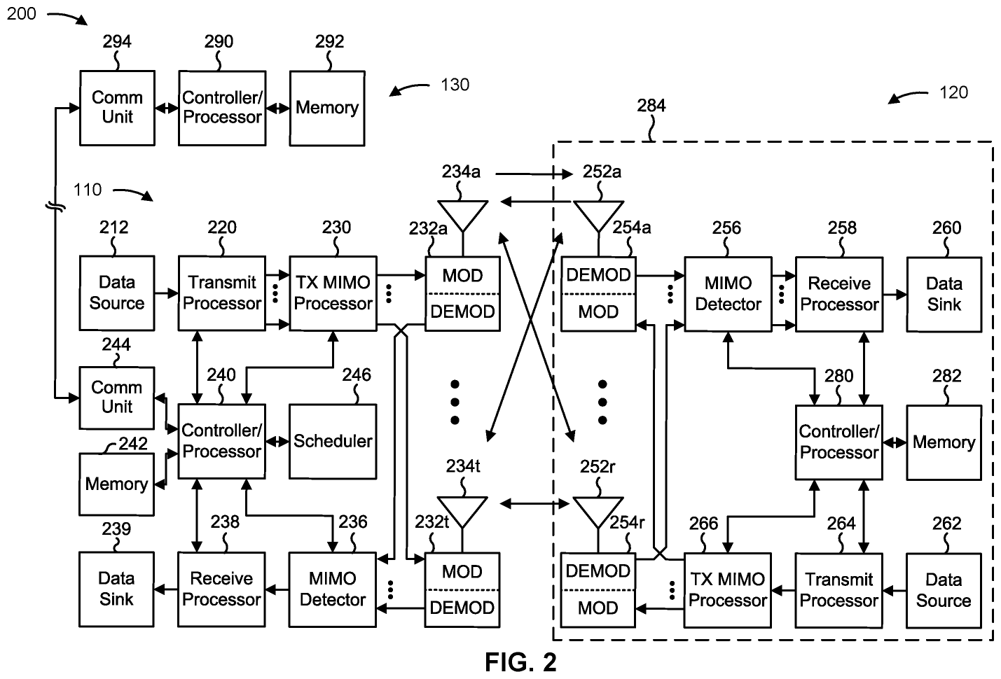

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T>1 and R>1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, an/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

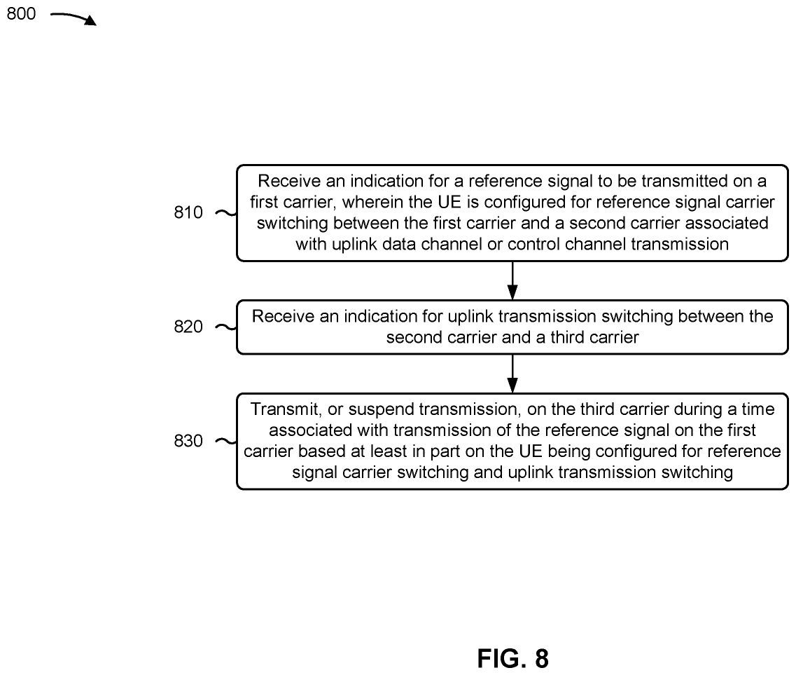

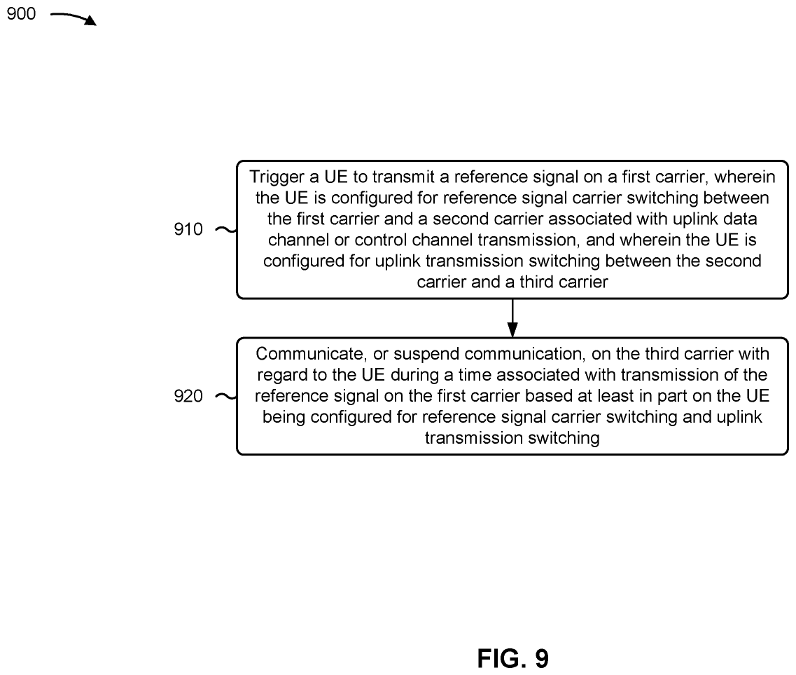

Controller/processor 240 of base station 110, controller/processor 280 of UE 120, and/or any other component(s) of FIG. 2 may perform one or more techniques associated with uplink transmission switching with sounding reference signal carrier switching, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some aspects, executing instructions may include running the instructions, converting the instructions, compiling the instructions, and/or interpreting the instructions.

In some aspects, the UE includes means for receiving an indication for a reference signal to be transmitted on a first carrier, wherein the UE is configured for reference signal carrier switching between the first carrier and a second carrier associated with uplink data channel or control channel transmission; means for receiving an indication for uplink transmission switching between the second carrier and a third carrier; and/or means for transmitting, or suspending transmission, on the third carrier during a time associated with transmission of the reference signal on the first carrier based at least in part on the UE being configured for reference signal carrier switching and uplink transmission switching. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for suspending transmission on the third carrier based at least in part on a sum of a first number of scheduled antenna ports on the third carrier and a second number of configured reference signal antenna ports exceeding the antenna port capability.

In some aspects, the UE includes means for temporarily suspending transmission on the third carrier during the time associated with transmission of the reference signal on the first carrier based at least in part on the UE being configured for reference signal carrier switching and uplink transmission switching.

In some aspects, the UE includes means for suspending transmission on the third carrier during the time associated with transmission of the reference signal on the first carrier based at least in part on configuration information indicating that the UE is to suspend transmission on the third carrier during the time associated with transmission of the reference signal on the first carrier.

In some aspects, the UE includes means for suspending transmission on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In some aspects, the UE includes means for transmitting on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In some aspects, the UE includes means for suspending transmission on the third carrier during the time associated with transmission of the reference signal on the first carrier based at least in part on a capability indicating that the UE is associated with a switched uplink.

In some aspects, the UE includes means for transmitting on the third carrier during the time associated with transmission of the reference signal on the first carrier based at least in part on a capability indicating that the UE is associated with a dual uplink.

In some aspects, the base station includes means for triggering a UE to transmit a reference signal on a first carrier, wherein the UE is configured for reference signal carrier switching between the first carrier and a second carrier associated with uplink data channel or control channel transmission, and wherein the UE is configured for uplink transmission switching between the second carrier and a third carrier; and/or means for communicating, or suspending communication, on the third carrier with regard to the UE during a time associated with transmission of the reference signal on the first carrier based at least in part on the UE being configured for reference signal carrier switching and uplink transmission switching. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, the base station includes means for suspending communication on the third carrier based at least in part on a sum of a first number of scheduled antenna ports on the third carrier and a second number of configured reference signal antenna ports exceeding the antenna port capability.

In some aspects, the base station includes means for temporarily suspending communication on the third carrier during the time associated with transmission of the reference signal on the first carrier based at least in part on the UE being configured for reference signal carrier switching and uplink transmission switching.

In some aspects, the base station includes means for suspending communication on the third carrier during the time associated with transmission of the reference signal on the first carrier based at least in part on configuration information indicating that the UE is to suspend transmission on the third carrier during the time associated with transmission of the reference signal on the first carrier.

In some aspects, the base station includes means for suspending communication on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In some aspects, the base station includes means for communicating on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In some aspects, the base station includes means for suspending communication on the third carrier during the time associated with transmission of the reference signal on the first carrier based at least in part on a capability indicating that the UE is associated with a switched uplink.

In some aspects, the base station includes means for communicating on the third carrier during the time associated with transmission of the reference signal on the first carrier based at least in part on a capability indicating that the UE is associated with a dual uplink.

As indicated above, FIG. 2 is provided as an example. Other examples may differ from what is described with regard to FIG. 2.

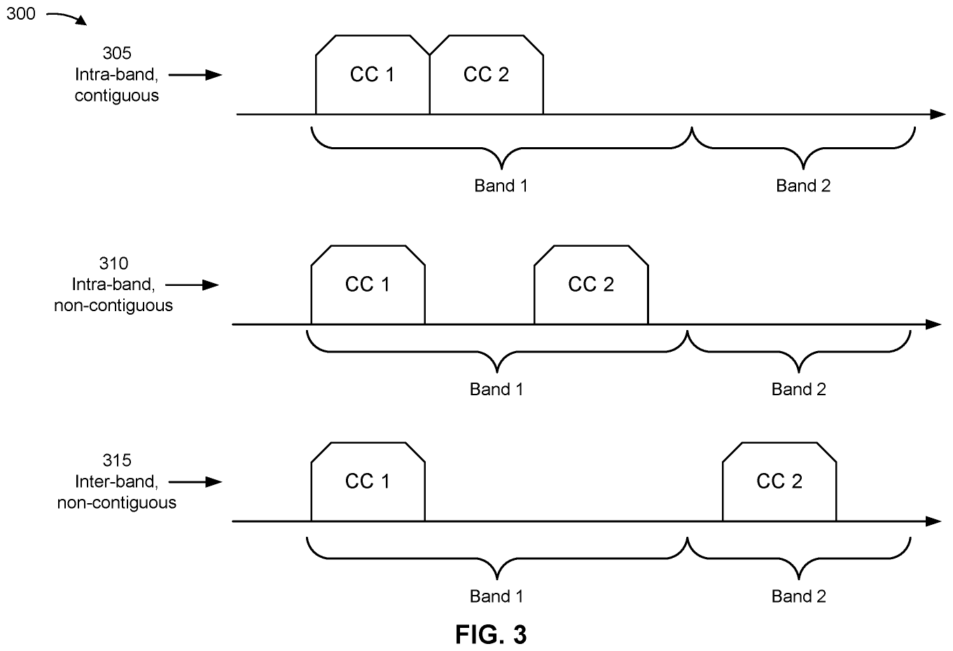

FIG. 3 is a diagram illustrating examples 300 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A base station 110 may configure carrier aggregation for a UE 120, such as in a radio resource control (RRC) message, downlink control information (DCI), and/or another signaling message.

As shown by reference number 305, in some aspects, carrier aggregation (CA) may be configured in an intra-band contiguous mode where the aggregated carriers are contiguous to one another and are in the same band. As shown by reference number 310, in some aspects, carrier aggregation may be configured in an intra-band non-contiguous mode where the aggregated carriers are non-contiguous to one another and are in the same band. As shown by reference number 315, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 3 is provided as an example. Other examples may differ from what is described with regard to FIG. 3.

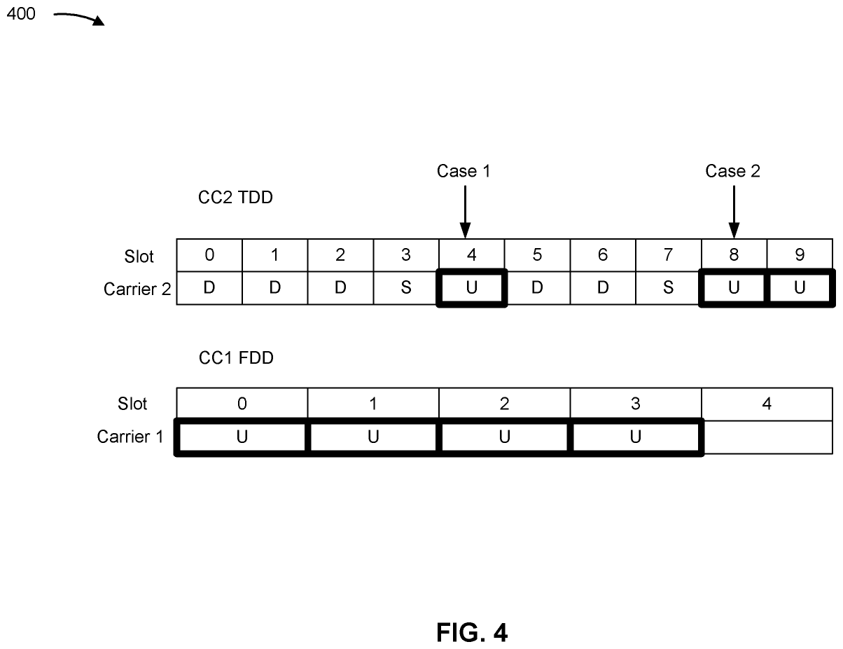

FIG. 4 is a diagram illustrating an example 400 of an uplink transmission switching configuration for a CA configuration of a UE, in accordance with the present disclosure. Example 400 shows a first CC (Carrier 1 or CC1) which is a frequency division duplexing (FDD) carrier. Only the uplink frequency division of the first CC is shown in example 400. Example 400 also shows a second CC (Carrier 2 or CC2) which is a time division duplexing (TDD) carrier. A series of slots (slots 0-4 on the first CC and slots 0-9 on the second CC) are shown. The first CC and the second CC are associated with different subcarrier spacings, so the first CC and the second CC have different slot lengths. Uplink slots, in which a UE can perform an uplink transmission, are indicated by “U” and a thick border. Downlink slots, in which the UE can receive a downlink transmission, are indicated by “D.” Special slots, in which the UE can be allocated a downlink transmission, an uplink transmission, or a switching gap, are indicated by “S.” Generally, special slots are associated with a downlink/uplink ratio of, say, 3:1 or 4:1, such that 3 special slots are configured as downlink slots for each special slot configured as an uplink slot. The first CC and the CC carrier are time aligned with each other, so, for example, slots 0 on the first and second CCs start at the same time.

An uplink transmission switching configuration may configure a UE to switch between the first CC and the second CC for uplink transmission. Due to thermal and power consumption limitations, a UE's uplink transmission chain usage may be limited to 2 separate transmit chains (e.g., radio frequency chains). For an inter-band CA scenario, such as that illustrated in FIG. 4, one common configuration is 1Tx (meaning a single transmission at a given time) on each band of 2 configured bands. Thus, in a first case (illustrated as case 1), the UE can perform a first transmission on the second CC in slot 4 and can perform a simultaneous second transmission on the first CC in slot 2. In a second case (illustrated as case 2), the UE can perform a first transmission and a second transmission on the second CC in slots 8 and 9, respectively, without performing a corresponding transmission on the first CC in slot 4. Thus, the first transmission may be fixed on the second component carrier, and the second transmission may switch between the first CC (in slot 2 on the first CC, for example) and the second CC (in slot 9 on the second CC, for example). Uplink transmission switching between different bands may enable uplink multiple input multiple output (MIMO) on a primary cell (PCell) (such as on a TDD band with 100 MHz bandwidth).

As indicated above, FIG. 4 is provided as an example. Other examples may differ from what is described with regard to FIG. 4.

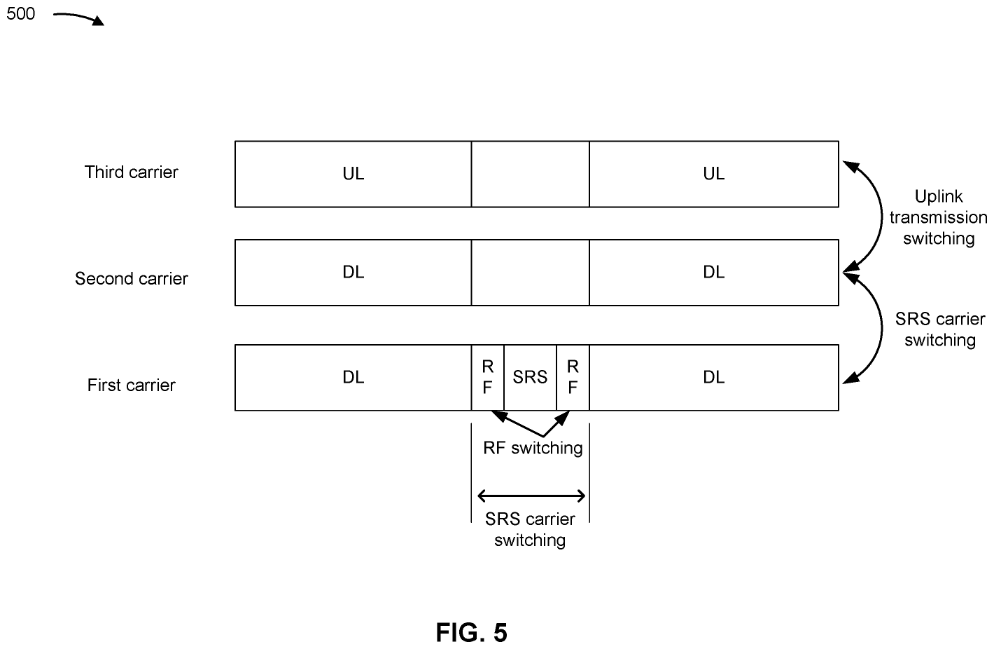

FIG. 5 is a diagram illustrating an example 500 of a CA configuration for a UE associated with an uplink transmission switching configuration and an SRS carrier switching configuration, in accordance with the present disclosure. The third carrier of FIG. 5 corresponds to the first carrier of FIG. 4, and the second carrier of FIG. 5 corresponds to the second carrier of FIG. 4. Thus, the third carrier may be an FDD carrier of which an uplink frequency division is shown, and the second carrier may be a TDD carrier. As shown, the second carrier and the third carrier may be associated with an uplink transmission switching configuration, as described in connection with FIG. 4.

Example 500 also includes a first carrier. The first carrier may be used for reference signal transmission, such as SRS transmission. An SRS is a signal transmitted by a UE in an uplink direction. A gNB may estimate uplink channel quality based at least in part on the SRS, and may use the estimated uplink channel quality to schedule downlink communications (based at least in part on a channel reciprocity property) or uplink communications. The third component carrier may be used only for downlink traffic (e.g., may not be scheduled with a physical uplink control channel (PUCCH) or a physical uplink shared channel (PUSCH).

As shown, the first carrier and the second carrier may be associated with an SRS carrier switching configuration. The SRS carrier switching configuration may indicate that the UE is to temporarily suspend uplink communication on the second carrier during a time associated with transmission of the SRS on the first carrier. For example, the time associated with transmission of the SRS on the first carrier is shown as an SRS carrier switching time, and includes a time resource associated with transmission of the SRS and/or one or more radio frequency (RF) switching gaps (also referred to as RF retuning times) before and after the time resource.

The behavior of the UE with regard to the third carrier may be unclear if the UE is configured for uplink transmission switching and for SRS carrier switching. For example, the SRS carrier switching configuration may indicate that the UE should suspend uplink transmission on the second carrier during the time associated with the transmission of the SRS on the first carrier. However, it may be unclear whether transmission should also be suspended on the third carrier during the time associated with the transmission of the SRS on the first carrier. This ambiguity may lead to sub-optimal resource allocation, under-utilization of UE capabilities, or exceeded UE capabilities, thereby diminishing the effectiveness of SRS transmission and the performance of uplink communications of the UE.

Some techniques and apparatuses described herein provide a rule for determining whether to suspend transmission on the third carrier during a time associated with transmission of a reference signal on the first carrier. In some aspects, the rule indicates that transmission on the third carrier may be suspended during the time if a sum of configured SRS antenna ports on the first carrier and scheduled antenna ports on the third carrier exceeds an antenna port capability of the UE, which improves performance of SRS transmission by providing additional headroom. In some aspects, the rule indicates that transmission on the third carrier is suspended during the time irrespective of the sum of antenna ports described above. The UE may determine the rule based at least in part on an explicit configuration (e.g., receiving information indicating whether to take the antenna port capability into account for determining whether to transmit on the third carrier during the time associated with the SRS transmission) or an implicit configuration (e.g., the UE may determine whether to take the antenna port capability into account for determining whether to transmit on the third carrier during the time associated with the SRS transmission). Thus, resource allocation and utilization of UE capabilities are improved, which improves the effectiveness of SRS transmission and the performance of uplink communications of the UE.

As indicated above, FIG. 5 is provided as an example. Other examples may differ from what is described with regard to FIG. 5.

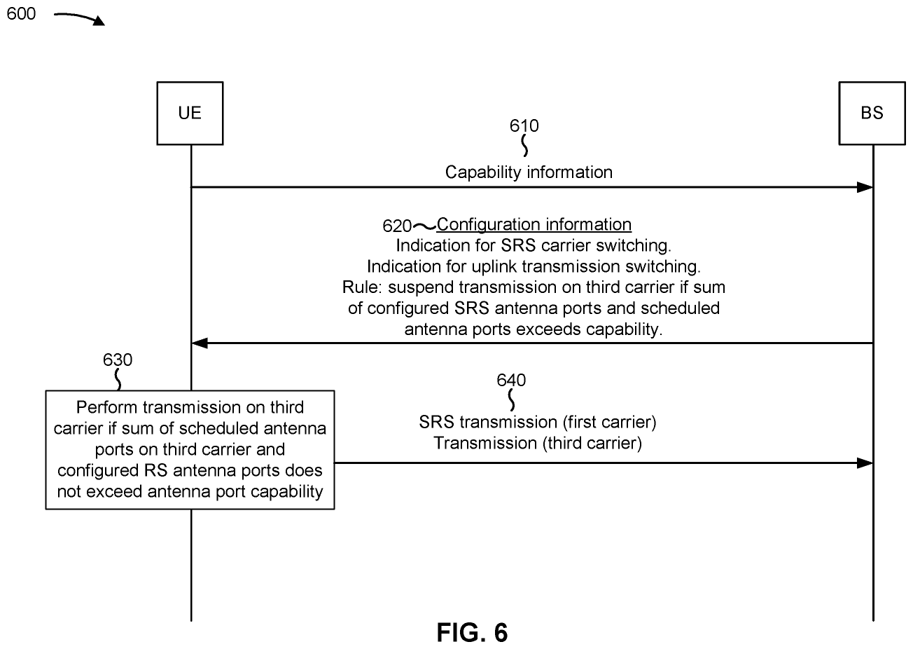

FIG. 6 is a diagram illustrating an example 600 of signaling associated with communication using an uplink transmission switching configuration and an SRS carrier switching configuration, in accordance with the present disclosure. As shown, example 600 includes a UE (e.g., UE 120) and a BS (e.g., BS 110). The UE may be configured with a first carrier for SRS transmission which may be grouped with a second carrier based at least in part on an SRS carrier switching configuration, as described below. Furthermore, the UE may be configured with a third carrier, which may be grouped with the second carrier based at least in part on an uplink transmission switching configuration, as described below. The first carrier may be configured with downlink slots and uplink slots, and without a PUSCH or a PUCCH.

As shown, the UE may transmit, to the BS, information indicating one or more capabilities. In some aspects, the information indicating the one or more capabilities may indicate an antenna port capability of the UE. An antenna port capability may indicate a number of antenna ports on which the UE can simultaneously transmit. In some aspects, an antenna port capability may indicate a number of antenna ports on which the UE can simultaneously transmit an SRS on a first carrier and one or more communications on a second carrier. For example, the antenna port capability may indicate a sum of a first number of scheduled antenna ports on the third carrier and a second number of configured reference signal antenna ports on the first carrier.

In some aspects, the capability information may indicate whether the UE is associated with a switched uplink configuration (indicated by a parameter “uplinkTxSwitchingOption” set to “switchedUL”) or a dual uplink configuration (indicated the parameter “uplinkTxSwitchingOption” set to “dualUL”). A switched uplink configuration may indicate that the UE is configured to or prefers to transmit on only one of the first carrier or the third carrier during a time associated with transmission of a reference signal (e.g., an SRS) on the first carrier. For example, a switched uplink configuration may indicate that the UE is not expected to transmit simultaneously on an uplink associated with a first RAT (e.g., NR) and an uplink associated with a second RAT (e.g., E-UTRA). A dual uplink capability may indicate that the UE is configured to or can transmit on both of the first carrier and the third carrier during a time associated with transmission of a reference signal (e.g., an SRS) on the first carrier. In some aspects, uplinkTxSwitchingOption may be indicated in a cell group configuration of the UE. Thus, in some aspects, the BS may have information indicating whether the UE is associated with a switched uplink or a dual uplink without receiving capability information from the UE indicating whether the UE is associated with the switched uplink or the dual uplink.

As shown by reference number 620, the UE may receive, from the BS, configuration information. In some aspects, the UE may receive the configuration information via radio resource control (RRC) signaling, medium access control (MAC) signaling, downlink control information (DCI), or a combination thereof. For example, a first part of the configuration information may be provided via an RRC message and a second part of the configuration information may be provided via MAC signaling or DCI. In some aspects, the configuration information may be provided via multiple, different communications, such as at different times. In some aspects, at least part of the configuration information may be received by the UE before the capability information is transmitted by the UE. In some aspects, at least part of the configuration information may include scheduling information.

As shown, in some aspects, the configuration information may include an indication for SRS carrier switching. For example, the configuration information may include an SRS carrier switching configuration that configures the UE to perform SRS carrier switching between the first carrier and the second carrier. In some aspects, the SRS carrier switching configuration may be provided with an SRS configuration for the SRS to be transmitted on the third carrier. In some aspects, the SRS carrier switching configuration may be provided separately from the SRS configuration. In some aspects, the SRS carrier switching configuration may include at least one of an srs-SwitchFromServCellIndex parameter, an srs-SwitchFromCarrier parameter, or the like. In some aspects, the SRS carrier switching configuration or the SRS configuration may indicate one or more RF switching times, such as via parameters switchingTimeUL and switchingTimeDL of a parameter srs-SwitchingTimeNR.

As further shown, in some aspects, the configuration information may include an indication for uplink transmission switching. For example, the configuration information may include an uplink transmission switching configuration that configures the UE to switch between the second carrier and the third carrier. In some aspects, the configuration information may indicate an uplink transmission switching configuration based at least in part on a parameter uplinkTxSwitching (e.g., uplinkTxSwitching-r16).

As further shown, in some aspects, the configuration information may indicate a rule for whether to suspend transmission on the third carrier if uplink transmission switching and SRS carrier switching are configured. For example, the UE may be explicitly configured with information indicating whether to suspend transmission on the third carrier based at least in part on an antenna port capability of the UE, or irrespective of an antenna port capability of the UE. In some aspects, the configuration information may indicate which rule is selected from a plurality of rules that can be selected. For example, a first rule may indicate that the UE should determine whether to suspend transmission on the third carrier based at least in part on an antenna port capability of the UE, and a second rule may indicate that the UE should determine to suspend transmission on the third carrier irrespective of the antenna port capability of the UE.

In some aspects, the configuration information may include information indicating whether the first rule or the second rule is selected. In some aspects, the UE may be preconfigured to support the first rule or the second rule. For example, one of the first rule or the second rule may be specified in a wireless communication standard. In example 600, the configuration information indicates that the UE should use the first rule, which indicates to perform transmission on the third carrier if the sum of the scheduled antenna ports on the third carrier and configured SRS antenna ports on the first carrier does not exceed an antenna port capability of the UE.

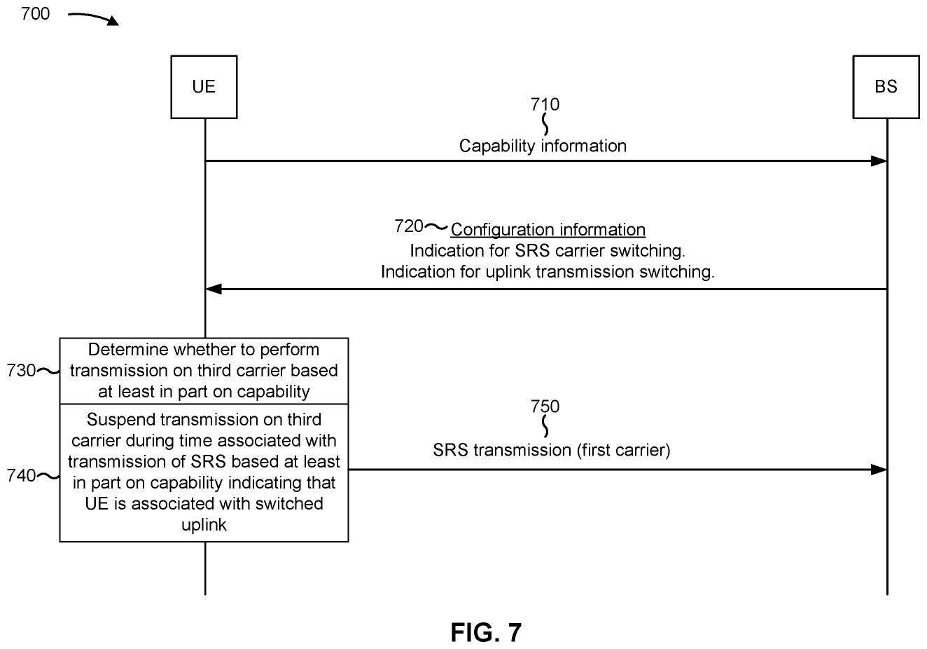

In some aspects, the UE may determine a rule to apply. The description below, accompanying FIG. 7, provides an example of such a determination.

In some aspects, the BS may select the rule based at least in part on a capability of the UE, such as the switched uplink configuration or the dual uplink configuration. For example, if the UE is associated with a switched uplink configuration, the BS may select, and may signal configuration information indicating, the second rule that indicates that the UE should determine to suspend transmission on the third carrier irrespective of the antenna port capability of the UE. If the UE is associated with a dual uplink configuration, the BS may select between the first rule and the second rule.

As shown by reference number 630, the UE may apply the first rule for uplink transmissions on the first carrier and the third carrier. For example, the UE may perform a transmission on the third carrier, during a time associated with transmission of an SRS on the first carrier, if a sum of a number of scheduled antenna ports on the third carrier and a number of configured SRS antenna ports does not exceed an antenna port capability of the UE. For example, if the UE's antenna port capability is 2, then the UE may determine that the UE can transmit on the third carrier during SRS transmission if 1 antenna port is scheduled on the third carrier and 1 SRS antenna port is configured on the first carrier, or if 2 SRS antenna ports are configured on the first carrier and no antenna ports are scheduled on the third carrier, or if 1 SRS antenna port is configured and no antenna port is scheduled on the third carrier. The UE may suspend transmission on the third carrier during the time associated with transmission of the SRS on the first carrier if the sum of scheduled antenna ports associated with transmission on the first carrier and configured SRS antenna ports exceeds an antenna port capability of the UE (e.g., if the UE's antenna port capability is less than the sum of the scheduled antenna ports and configured SRS antenna ports). In example 600, the UE determines to transmit the SRS on the first carrier and the transmission on the third carrier during the time associated with transmission of the SRS. Accordingly, as shown by reference number 640, the UE contemporaneously transmits the SRS transmission and the transmission on the third carrier. The description accompanying FIG. 7 provides an example of application of the second rule.

An example of the first rule is as follows:
A UE can be configured with SRS resource(s) on a carrier c₁ (e.g., the first carrier) with slot formats comprised of downlink (DL) and uplink (UL) symbols and not configured for PUSCH/PUCCH transmission. For carrier c₁, the UE is configured with higher layer parameter srs-SwitchFromServCellIndex and srs-SwitchFromCarrier the switching from carrier c₂ (e.g., the second carrier) which is configured for PUSCH/PUCCH transmission. During SRS transmission on carrier c₁ (including any interruption due to uplink or downlink RF retuning time as defined by higher layer parameters switchingTimeUL and switchingTimeDL of srs-SwitchingTimeNR), the UE temporarily suspends the uplink transmission on carrier c₂. If the UE is configured with uplinkTxSwitching-r16 for uplink switching between c₂ and a third carrier c₃ (e.g., the third carrier) and the sum of configured SRS antenna ports and scheduled antenna ports on c₃ exceeds the UE reported capability, the UE temporarily suspends the uplink transmission on carrier c₃ during the SRS transmission on carrier c₁ (including any interruption due to uplink or downlink RF retuning time as defined by higher layer parameters switchingTimeUL and switchingTimeDL of srs-SwitchingTimeNR).

In this way, the UE improves resource utilization and the rule reduces ambiguity regarding how communications on the first carrier should be treated during SRS transmission.

As indicated above, FIG. 6 is provided as an example. Other examples may differ from what is described with regard to FIG. 6.

FIG. 7 is a diagram illustrating an example 700 of signaling associated with communication using an uplink transmission switching configuration and an SRS carrier switching configuration, in accordance with the present disclosure. As shown, example 700 includes a UE (e.g., UE 120) and a BS (e.g., BS 110). The UE may be configured with a first carrier for SRS transmission which may be grouped with a second carrier based at least in part on an SRS carrier switching configuration, as described below. Furthermore, the UE may be configured with a third carrier, which may be grouped with the second carrier based at least in part on an uplink transmission switching configuration, as described below. The first carrier may be configured with downlink slots and uplink slots, and without a PUSCH or a PUCCH.

As shown by reference number 710, the UE may transmit, to the BS, capability information (e.g., information indicating one or more capabilities). This information is described in more detail with regard to reference number 610 of FIG. 6.

As shown by reference number 720, the UE may receive, from the BS, configuration information. In some aspects, the UE may receive the configuration information via RRC signaling, MAC signaling, DCI, or a combination thereof. For example, a first part of the configuration information may be provided via an RRC message and a second part of the configuration information may be provided via MAC signaling or DCI. In some aspects, the configuration information may be provided via multiple, different communications, such as at different times. In some aspects, at least part of the configuration information may be received by the UE before the capability information is transmitted by the UE. In some aspects, at least part of the configuration information may include scheduling information.

As shown, in some aspects, the configuration information may include an indication for SRS carrier switching, as described in connection with reference number 620 of FIG. 6. As further shown, in some aspects, the configuration information may include an indication for uplink transmission switching, as described in connection with reference number 620 of FIG. 6.

As shown by reference number 730, the UE may determine whether to perform transmission on the third carrier based at least in part on a capability of the UE. For example, the UE may determine whether to use the first rule or the second rule described above in connection with FIG. 6. In other words, the UE may select one of the first rule or the second rule for determining whether to transmit on the third carrier during SRS transmission on the first carrier. This may be considered implicit configuration of the UE to use the first rule or the second rule. In some aspects, the UE may select the rule based at least in part on a capability of the UE, such as the switched uplink configuration or the dual uplink configuration. For example, if the UE is associated with a switched uplink configuration, the UE may select the second rule that indicates that the UE should determine to suspend transmission on the third carrier irrespective of the antenna port capability of the UE. If the UE is associated with a dual uplink configuration, the UE may select the first rule, or may select between the first rule and the second rule based at least in part on one or more other parameters.

An example of a specification for the UE determining whether to apply the first rule or the second rule is as follows:
A UE can be configured with SRS resource(s) on a carrier c₁ with slot formats comprised of DL and UL symbols and not configured for PUSCH/PUCCH transmission. For carrier c₁ (e.g., the first carrier), the UE is configured with higher layer parameter srs-SwitchFromServCellIndex and srs-SwitchFromCarrier the switching from carrier c₂ (e.g., the second carrier) which is configured for PUSCH/PUCCH transmission. During SRS transmission on carrier c₁ (including any interruption due to uplink or downlink RF retuning time as defined by higher layer parameters switchingTimeUL and switchingTimeDL of srs-SwitchingTimeNR), the UE temporarily suspends the uplink transmission on carrier c₂. For the UE is configured with uplinkTxSwitching-r16 for uplink switching between c₂ and a third carrier c₃ (e.g., the third carrier) and configured with uplinkTxSwitchingOption set to ‘dualUL’, if the sum of configured SRS antenna ports and scheduled antenna ports on c₃ exceeds the UE reported capability, the UE temporarily suspends the uplink transmission on carrier c₃ during the SRS transmission on carrier c₁ (including any interruption due to uplink or downlink RF retuning time as defined by higher layer parameters switchingTimeUL and switchingTimeDL of srs-SwitchingTimeNR). For the UE is configured with uplinkTxSwitching-r16 for uplink switching between c₂ and a third carrier c₃ and configured with uplinkTxSwitchingOption set to ‘switchedUL’, the UE temporarily suspends the uplink transmission on carrier c₃ during the SRS transmission on carrier c₁ (including any interruption due to uplink or downlink RF retuning time as defined by higher layer parameters switchingTimeUL and switchingTimeDL of srs-SwitchingTimeNR).

As shown by reference number 740, the UE may apply the second rule for uplink transmissions on the first carrier and the third carrier. For example, the UE may suspend transmission on the third carrier, during a time associated with transmission of an SRS on the first carrier, irrespective of an antenna port capability of the UE. As mentioned above, the UE may apply the second rule based at least in part on the UE being associated with a switched uplink configuration. Accordingly, as shown by reference number 750, the UE transmits the SRS transmission without contemporaneous transmission on the third carrier.

An example of the second rule is as follows:
A UE can be configured with SRS resource(s) on a carrier c₁ (e.g., the first carrier) with slot formats comprised of DL and UL symbols and not configured for PUSCH/PUCCH transmission. For carrier c₁, the UE is configured with higher layer parameter srs-SwitchFromServCellIndex and srs-SwitchFromCarrier the switching from carrier c₂ (e.g., the second carrier) which is configured for PUSCH/PUCCH transmission. During SRS transmission on carrier c₁ (including any interruption due to uplink or downlink RF retuning time as defined by higher layer parameters switchingTimeUL and switchingTimeDL of srs-SwitchingTimeNR), the UE temporarily suspends the uplink transmission on carrier c₂. If the UE is configured with uplinkTxSwitching-r16 for uplink switching between c₂ and a third carrier c₃ (e.g., the third carrier), the UE temporarily suspends the uplink transmission on carrier c₃ during the SRS transmission on carrier c₁ (including any interruption due to uplink or downlink RF retuning time as defined by higher layer parameters switchingTimeUL and switchingTimeDL of srs-SwitchingTimeNR).

In this way, the UE improves resource utilization and the rule reduces ambiguity regarding how communications on the first carrier should be treated during SRS transmission.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with uplink transmission switching with sounding reference signal carrier switching.

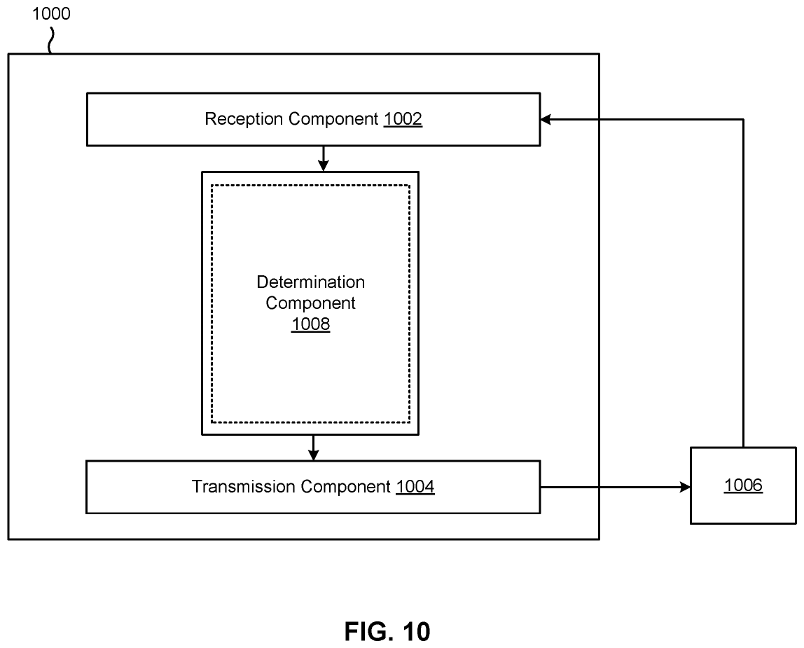

As shown in FIG. 8, in some aspects, process 800 may include receiving an indication for a reference signal to be transmitted on a first carrier, wherein the UE is configured for reference signal carrier switching between the first carrier and a second carrier associated with uplink data channel or control channel transmission (block 810). For example, the UE (e.g., using reception component 1002, depicted in FIG. 10) may receive an indication for a reference signal to be transmitted on a first carrier, wherein the UE is configured for reference signal carrier switching between the first carrier and a second carrier associated with uplink data channel or control channel transmission, as described above.

As further shown in FIG. 8, in some aspects, process 800 may include receiving an indication for uplink transmission switching between the second carrier and a third carrier (block 820). For example, the UE (e.g., using reception component 1002, depicted in FIG. 10) may receive an indication for uplink transmission switching between the second carrier and a third carrier, as described above.

As further shown in FIG. 8, in some aspects, process 800 may include transmitting, or suspending transmission, on the third carrier during a time associated with transmission of the reference signal on the first carrier based at least in part on the UE being configured for reference signal carrier switching and uplink transmission switching (block 830). For example, the UE (e.g., using transmission component 1004, depicted in FIG. 10) may transmit, or suspend transmission, on the third carrier during a time associated with transmission of the reference signal on the first carrier based at least in part on the UE being configured for reference signal carrier switching and uplink transmission switching, as described above.

Process 800 may include additional aspects, such as any single aspect or any combination of aspects described below and/or in connection with one or more other processes described elsewhere herein.

In a first aspect, transmitting or suspending transmission on the third carrier is based at least in part on an antenna port capability of the UE.

In a second aspect, alone or in combination with the first aspect, transmitting or suspending transmission on the third carrier further comprises suspending transmission on the third carrier based at least in part on a sum of a first number of scheduled antenna ports on the third carrier and a second number of configured reference signal antenna ports exceeding the antenna port capability.

In a third aspect, alone or in combination with one or more of the first and second aspects, transmitting or suspending transmission on the third carrier further comprises temporarily suspending transmission on the third carrier during the time associated with transmission of the reference signal on the first carrier based at least in part on the UE being configured for reference signal carrier switching and uplink transmission switching.

In a fourth aspect, alone or in combination with one or more of the first through third aspects, transmitting or suspending transmission on the third carrier further comprises suspending transmission on the third carrier during the time associated with transmission of the reference signal on the first carrier based at least in part on configuration information indicating that the UE is to suspend transmission on the third carrier during the time associated with transmission of the reference signal on the first carrier.

In a fifth aspect, alone or in combination with one or more of the first through fourth aspects, the configuration information is based at least in part on a capability indicating that the UE is associated with a switched uplink.

In a sixth aspect, alone or in combination with one or more of the first through fifth aspects, transmitting or suspending transmission on the third carrier further comprises suspending transmission on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In a seventh aspect, alone or in combination with one or more of the first through sixth aspects, transmitting or suspending transmission on the third carrier further comprises transmitting on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In an eighth aspect, alone or in combination with one or more of the first through seventh aspects, transmitting or suspending transmission on the third carrier further comprises suspending transmission on the third carrier during the time associated with transmission of the reference signal on the first carrier based at least in part on a capability indicating that the UE is associated with a switched uplink.

In a ninth aspect, alone or in combination with one or more of the first through eighth aspects, transmitting or suspending transmission on the third carrier further comprises transmitting on the third carrier during the time associated with transmission of the reference signal on the first carrier based at least in part on a capability indicating that the UE is associated with a dual uplink.

In a tenth aspect, alone or in combination with one or more of the first through ninth aspects, the first carrier is a time division duplexing carrier configured with DL and UL slots but without an uplink data channel or control channel transmission.

In an eleventh aspect, alone or in combination with one or more of the first through tenth aspects, the reference signal is an SRS and the time associated with transmission of the reference signal includes at least one of an SRS transmission time, or a radio frequency retuning time.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with uplink transmission switching with sounding reference signal carrier switching.

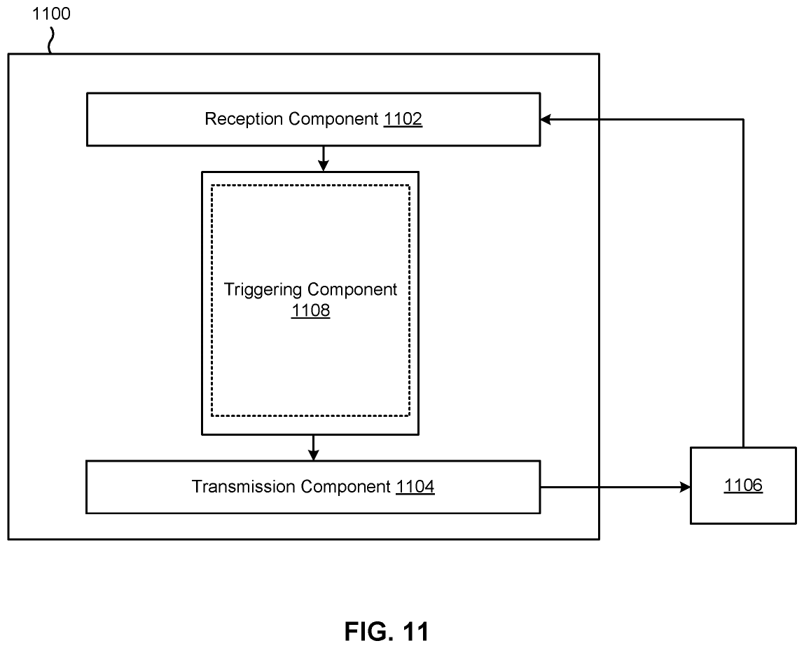

As shown in FIG. 9, in some aspects, process 900 may include triggering a UE to transmit a reference signal on a first carrier, wherein the UE is configured for reference signal carrier switching between the first carrier and a second carrier associated with uplink data channel or control channel transmission, and wherein the UE is configured for uplink transmission switching between the second carrier and a third carrier (block 910). For example, the base station (e.g., using triggering component 1108, depicted in FIG. 11) may trigger a UE to transmit a reference signal on a first carrier, wherein the UE is configured for reference signal carrier switching between the first carrier and a second carrier associated with uplink data channel or control channel transmission, and wherein the UE is configured for uplink transmission switching between the second carrier and a third carrier, as described above.

As further shown in FIG. 9, in some aspects, process 900 may include communicating, or suspending communication, on the third carrier with regard to the UE during a time associated with transmission of the reference signal on the first carrier based at least in part on the UE being configured for reference signal carrier switching and uplink transmission switching (block 920). For example, the base station (e.g., using transmission component 1104 or reception component 1102, depicted in FIG. 11) may communicate, or suspend communication, on the third carrier with regard to the UE during a time associated with transmission of the reference signal on the first carrier based at least in part on the UE being configured for reference signal carrier switching and uplink transmission switching, as described above.

Process 900 may include additional aspects, such as any single aspect or any combination of aspects described below and/or in connection with one or more other processes described elsewhere herein.

In a first aspect, communicating or suspending communication on the third carrier is based at least in part on an antenna port capability of the UE.

In a second aspect, alone or in combination with the first aspect, communicating or suspending communication on the third carrier further comprises suspending communication on the third carrier based at least in part on a sum of a first number of scheduled antenna ports on the third carrier and a second number of configured reference signal antenna ports exceeding the antenna port capability.

In a third aspect, alone or in combination with one or more of the first and second aspects, communicating or suspending communication on the third carrier further comprises temporarily suspending communication on the third carrier during the time associated with transmission of the reference signal on the first carrier based at least in part on the UE being configured for reference signal carrier switching and uplink transmission switching.

In a fourth aspect, alone or in combination with one or more of the first through third aspects, communicating or suspending communication on the third carrier further comprises suspending communication on the third carrier during the time associated with transmission of the reference signal on the first carrier based at least in part on configuration information indicating that the UE is to suspend transmission on the third carrier during the time associated with transmission of the reference signal on the first carrier.

In a fifth aspect, alone or in combination with one or more of the first through fourth aspects, the configuration information is based at least in part on a capability indicating that the UE is associated with a switched uplink.

In a sixth aspect, alone or in combination with one or more of the first through fifth aspects, communicating or suspending communication on the third carrier further comprises suspending communication on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

In a seventh aspect, alone or in combination with one or more of the first through sixth aspects, communicating or suspending communication on the third carrier further comprises communicating on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

In an eighth aspect, alone or in combination with one or more of the first through seventh aspects, communicating or suspending communication on the third carrier further comprises suspending communication on the third carrier during the time associated with transmission of the reference signal on the first carrier based at least in part on a capability indicating that the UE is associated with a switched uplink.

In a ninth aspect, alone or in combination with one or more of the first through eighth aspects, communicating or suspending communication on the third carrier further comprises communicating on the third carrier during the time associated with transmission of the reference signal on the first carrier based at least in part on a capability indicating that the UE is associated with a dual uplink.

In a tenth aspect, alone or in combination with one or more of the first through ninth aspects, the first carrier is a time division duplexing carrier configured without an uplink data channel or control channel transmission.

In an eleventh aspect, alone or in combination with one or more of the first through tenth aspects, the reference signal is an SRS and the time associated with transmission of the reference signal includes at least one of an SRS transmission time, or a radio frequency retuning time.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a determination component 1008, among other examples.

In some aspects, the apparatus 1000 may be configured to perform one or more operations described herein in connection with FIGS. 3-7. Additionally, or alternatively, the apparatus 1000 may be configured to perform one or more processes described herein, such as process 800 of FIG. 8 or a combination thereof. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The reception component 1002 may receive an indication for a reference signal to be transmitted on a first carrier, wherein the UE is configured for reference signal carrier switching between the first carrier and a second carrier associated with uplink data channel or control channel transmission. The reception component 1002 may receive an indication for uplink transmission switching between the second carrier and a third carrier. The transmission component 1004 may transmit, or suspend transmission, on the third carrier during a time associated with transmission of the reference signal on the first carrier based at least in part on the UE being configured for reference signal carrier switching and uplink transmission switching. The determination component 1008 may determine whether to apply a first rule that takes into account an antenna port capability of the UE, or a second rule that does not take into account the antenna port capability of the UE, to determine whether to transmit or suspend transmission.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a triggering component 1108, among other examples.

In some aspects, the apparatus 1100 may be configured to perform one or more operations described herein in connection with FIGS. 3-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the base station described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the base station described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the base station described above in connection with FIG. 2. In some aspects, the transmission component 1104 may be co-located with the reception component 1102 in a transceiver.

The triggering component 1108 may trigger a UE to transmit a reference signal on a first carrier, wherein the UE is configured for reference signal carrier switching between the first carrier and a second carrier associated with uplink data channel or control channel transmission, and wherein the UE is configured for uplink transmission switching between the second carrier and a third carrier. The reception component 1102 and/or the transmission component 1104 may communicate, or suspend communication, on the third carrier with regard to the UE during a time associated with transmission of the reference signal on the first carrier based at least in part on the UE being configured for reference signal carrier switching and uplink transmission switching.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving an indication for a reference signal to be transmitted on a first carrier, wherein the UE is configured for reference signal carrier switching between the first carrier and a second carrier associated with uplink data channel or control channel transmission; receiving an indication for uplink transmission switching between the second carrier and a third carrier; and transmitting, or suspending transmission, on the third carrier during a time associated with transmission of the reference signal on the first carrier based at least in part on the UE being configured for reference signal carrier switching and uplink transmission switching.

Aspect 2: The method of Aspect 1, wherein transmitting or suspending transmission on the third carrier is based at least in part on an antenna port capability of the UE.

Aspect 3: The method of Aspect 2, wherein transmitting or suspending transmission on the third carrier further comprises: suspending transmission on the third carrier based at least in part on a sum of a first number of scheduled antenna ports on the third carrier and a second number of configured reference signal antenna ports exceeding the antenna port capability.

Aspect 4: The method of any of Aspects 1-3, wherein transmitting or suspending transmission on the third carrier further comprises: temporarily suspending transmission on the third carrier during the time associated with transmission of the reference signal on the first carrier based at least in part on the UE being configured for reference signal carrier switching and uplink transmission switching.

Aspect 5: The method of any of Aspects 1-4, wherein transmitting or suspending transmission on the third carrier further comprises: suspending transmission on the third carrier during the time associated with transmission of the reference signal on the first carrier based at least in part on configuration information indicating that the UE is to suspend transmission on the third carrier during the time associated with transmission of the reference signal on the first carrier.

Aspect 6: The method of Aspect 5, wherein the configuration information is based at least in part on a capability indicating that the UE is associated with a switched uplink.

Aspect 7: The method of any of Aspects 1-6, wherein transmitting or suspending transmission on the third carrier further comprises: suspending transmission on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

Aspect 8: The method of any of Aspects 1-7, wherein transmitting or suspending transmission on the third carrier further comprises: transmitting on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

Aspect 9: The method of any of Aspects 1-8, wherein transmitting or suspending transmission on the third carrier further comprises: suspending transmission on the third carrier during the time associated with transmission of the reference signal on the first carrier based at least in part on a capability indicating that the UE is associated with a switched uplink.

Aspect 10: The method of any of Aspects 1-9, wherein transmitting or suspending transmission on the third carrier further comprises: transmitting on the third carrier during the time associated with transmission of the reference signal on the first carrier based at least in part on a capability indicating that the UE is associated with a dual uplink.

Aspect 11: The method of any of Aspects 1-10, wherein the first carrier is a time division duplexing carrier configured with DL and UL slots but without an uplink data channel or control channel transmission.

Aspect 12: The method of any of Aspects 1-11, wherein the reference signal is a sounding reference signal (SRS) and the time associated with transmission of the reference signal includes at least one of: an SRS transmission time, or a radio frequency retuning time.

Aspect 13: A method of wireless communication performed by a base station, comprising: triggering a UE to transmit a reference signal on a first carrier, wherein the UE is configured for reference signal carrier switching between the first carrier and a second carrier associated with uplink data channel or control channel transmission, and wherein the UE is configured for uplink transmission switching between the second carrier and a third carrier; and communicating, or suspending communication, on the third carrier with regard to the UE during a time associated with transmission of the reference signal on the first carrier based at least in part on the UE being configured for reference signal carrier switching and uplink transmission switching.

Aspect 14: The method of Aspect 13, wherein communicating or suspending communication on the third carrier is based at least in part on an antenna port capability of the UE.

Aspect 15: The method of Aspect 14, wherein communicating or suspending communication on the third carrier further comprises: suspending communication on the third carrier based at least in part on a sum of a first number of scheduled antenna ports on the third carrier and a second number of configured reference signal antenna ports exceeding the antenna port capability.

Aspect 16: The method of any of Aspects 13-15, wherein communicating or suspending communication on the third carrier further comprises: temporarily suspending communication on the third carrier during the time associated with transmission of the reference signal on the first carrier based at least in part on the UE being configured for reference signal carrier switching and uplink transmission switching.

Aspect 17: The method of any of Aspects 13-16, wherein communicating or suspending communication on the third carrier further comprises: suspending communication on the third carrier during the time associated with transmission of the reference signal on the first carrier based at least in part on configuration information indicating that the UE is to suspend transmission on the third carrier during the time associated with transmission of the reference signal on the first carrier.

Aspect 18: The method of Aspect 17, wherein the configuration information is based at least in part on a capability indicating that the UE is associated with a switched uplink.

Aspect 19: The method of any of Aspects 13-18, wherein communicating or suspending communication on the third carrier further comprises: suspending communication on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

Aspect 20: The method of any of Aspects 13-19, wherein communicating or suspending communication on the third carrier further comprises: communicating on the third carrier during the time associated with transmission of the reference signal on the first carrier based at least in part on configuration information indicating that the UE is to transmit on the third carrier, wherein the configuration information is based at least in part on a capability indicating that the UE is associated with a dual uplink.

Aspect 21: The method of any of Aspects 13-20, wherein communicating or suspending communication on the third carrier further comprises: suspending communication on the third carrier during the time associated with transmission of the reference signal on the first carrier based at least in part on a capability indicating that the UE is associated with a switched uplink.

Aspect 22: The method of any of Aspects 13-21, wherein communicating or suspending communication on the third carrier further comprises: communicating on the third carrier during the time associated with transmission of the reference signal on the first carrier based at least in part on a capability indicating that the UE is associated with a dual uplink.

Aspect 23: The method of any of Aspects 13-22, wherein the first carrier is a time division duplexing carrier configured without an uplink data channel or control channel transmission.

Aspect 24: The method of any of Aspects 13-23, wherein the reference signal is a sounding reference signal (SRS) and the time associated with transmission of the reference signal includes at least one of: an SRS transmission time, or a radio frequency retuning time.

Aspect 25: An apparatus for wireless communication at a device, comprising a processor; memory coupled with the processor; and instructions stored in the memory and executable by the processor to cause the apparatus to perform the method of one or more Aspects of Aspects 1-24.

Aspect 26: A device for wireless communication, comprising a memory and one or more processors coupled to the memory, the memory and the one or more processors configured to perform the method of one or more Aspects of Aspects 1-24.

Aspect 27: An apparatus for wireless communication, comprising at least one means for performing the method of one or more Aspects of Aspects 1-24.

Aspect 28: A non-transitory computer-readable medium storing code for wireless communication, the code comprising instructions executable by a processor to perform the method of one or more Aspects of Aspects 1-24.

Aspect 29: A non-transitory computer-readable medium storing a set of instructions for wireless communication, the set of instructions comprising one or more instructions that, when executed by one or more processors of a device, cause the device to perform the method of one or more Aspects of Aspects 1-24.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving a reference signal carrier switching configuration for reference signal carrier switching between a first carrier and a second carrier associated with an uplink data channel or an uplink control channel transmission;
receiving an indication for uplink transmission switching between the second carrier and a third carrier; and
suspending transmission on the third carrier during a time associated with transmission of a reference signal on the first carrier based at least in part on the UE being configured for the reference signal carrier switching and the uplink transmission switching.

2-3. (canceled)

4. The method of claim 1, wherein suspending transmission on the third carrier further comprises:
temporarily suspending transmission on the third carrier during the time associated with transmission of the reference signal on the first carrier based at least in part on the UE being configured for reference signal carrier switching and uplink transmission switching.

5. The method of claim 1, wherein suspending transmission on the third carrier further comprises:
suspending transmission on the third carrier during the time associated with transmission of the reference signal on the first carrier based at least in part on configuration information indicating that the UE is to suspend transmission on the third carrier during the time associated with transmission of the reference signal on the first carrier.

6. The method of claim 5, wherein the configuration information is based at least in part on a capability indicating that the UE is associated with a switched uplink.

7-10. (canceled)

11. The method of claim 1, wherein the first carrier is a time division duplexing carrier configured with DL and UL slots but without an uplink data channel or control channel transmission.

12. The method of claim 1, wherein the reference signal is a sounding reference signal (SRS) and the time associated with transmission of the reference signal includes at least one of:
an SRS transmission time, or
a radio frequency retuning time.

13. A method of wireless communication performed by a network node, comprising:
transmitting a reference signal carrier switching configuration that configures a user equipment (UE) to perform reference signal carrier switching between a first carrier and a second carrier associated with an uplink data channel or an uplink control channel transmission, wherein the UE is configured for uplink transmission switching between the second carrier and a third carrier; and
suspending communication on the third carrier with regard to the UE during a time associated with transmission of the reference signal on the first carrier based at least in part on the UE being configured for the reference signal carrier switching and the uplink transmission switching.

14-15. (canceled)

16. The method of claim 13, wherein suspending communication on the third carrier further comprises:
temporarily suspending communication on the third carrier during the time associated with transmission of the reference signal on the first carrier based at least in part on the UE being configured for reference signal carrier switching and uplink transmission switching.

17. The method of claim 13, wherein suspending communication on the third carrier further comprises:
suspending communication on the third carrier during the time associated with transmission of the reference signal on the first carrier based at least in part on configuration information indicating that the UE is to suspend transmission on the third carrier during the time associated with transmission of the reference signal on the first carrier.

18. The method of claim 17, wherein the configuration information is based at least in part on a capability indicating that the UE is associated with a switched uplink.

19-24. (canceled)

25. A user equipment (UE) for wireless communication, comprising:
one or more memories; and
one or more processors coupled to the one or more memories, the one or more processors configured to:
receive a a reference signal carrier switching configuration for reference signal carrier switching between a first carrier and a second carrier associated with an uplink data channel or an uplink control channel transmission;
receive an indication for uplink transmission switching between the second carrier and a third carrier; and
suspend transmission on the third carrier during a time associated with transmission of the reference signal on the first carrier based at least in part on the UE being configured for the reference signal carrier switching and the uplink transmission switching.

26-27. (canceled)

28. The UE of claim 25, wherein the one or more processors, when suspending transmission on the third carrier, are configured to:
temporarily suspend transmission on the third carrier during the time associated with transmission of the reference signal on the first carrier based at least in part on the UE being configured for reference signal carrier switching and uplink transmission switching.

29. The UE of claim 25, wherein the one or more processors, when suspending transmission on the third carrier, are configured to:
suspend transmission on the third carrier during the time associated with transmission of the reference signal on the first carrier based at least in part on configuration information indicating that the UE is to suspend transmission on the third carrier during the time associated with transmission of the reference signal on the first carrier.

30. The UE of claim 29, wherein the configuration information is based at least in part on a capability indicating that the UE is associated with a switched uplink.

31. The UE of claim 25, wherein the one or more processors, when suspending transmission on the third carrier, are configured to:
suspend transmission on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

32. (canceled)

33. The UE of claim 25, wherein the one or more processors, when suspending transmission on the third carrier, are configured to:
suspend transmission on the third carrier during the time associated with transmission of the reference signal on the first carrier based at least in part on a capability indicating that the UE is associated with a switched uplink.

34. (canceled)

35. The UE of claim 25, wherein the first carrier is a time division duplexing carrier configured with DL and UL slots but without an uplink data channel or control channel transmission.

36. The UE of claim 25, wherein the reference signal is a sounding reference signal (SRS) and the time associated with transmission of the reference signal includes at least one of:
an SRS transmission time, or
a radio frequency retuning time.

37. A network node for wireless communication, comprising:
one or more memories; and
one or more processors coupled to the one or more memories, the one or more processors configured to:
transmit a reference signal carrier switching configuration that configures a user equipment (UE) to perform reference signal carrier switching between a first carrier and a second carrier associated with an uplink data channel or an uplink control channel transmission, wherein the UE is configured for uplink transmission switching between the second carrier and a third carrier; and
suspend communication on the third carrier with regard to the UE during a time associated with transmission of the reference signal on the first carrier based at least in part on the UE being configured for reference signal carrier switching and uplink transmission switching.

38-39. (canceled)

40. The network node of claim 37, wherein the one or more processors, when suspending communication on the third carrier, are configured to:
temporarily suspend communication on the third carrier during the time associated with transmission of the reference signal on the first carrier based at least in part on the UE being configured for reference signal carrier switching and uplink transmission switching.

41. The network node of claim 37, wherein the one or more processors, when suspending communication on the third carrier, are configured to:
suspend communication on the third carrier during the time associated with transmission of the reference signal on the first carrier based at least in part on configuration information indicating that the UE is to suspend transmission on the third carrier during the time associated with transmission of the reference signal on the first carrier.

42. The network node of claim 41, wherein the configuration information is based at least in part on a capability indicating that the UE is associated with a switched uplink.

43. The network node of claim 37, wherein the one or more processors, when suspending communication on the third carrier, are configured to:
suspend communication on the third carrier during the time associated with transmission of the reference signal on the first carrier based at least in part on configuration information indicating that the UE is to suspend transmission on the third carrier, wherein the configuration information is based at least in part on a capability indicating that the UE is associated with a dual uplink.

44. (canceled)

45. The network node of claim 37, wherein the one or more processors, when suspending communication on the third carrier, are configured to:
suspend communication on the third carrier during the time associated with transmission of the reference signal on the first carrier based at least in part on a capability indicating that the UE is associated with a switched uplink.

46. (canceled)

47. The network node of claim 37, wherein the first carrier is a time division duplexing carrier configured without an uplink data channel or control channel transmission.

48. The network node of claim 37, wherein the reference signal is a sounding reference signal (SRS) and the time associated with transmission of the reference signal includes at least one of:
an SRS transmission time, or
a radio frequency retuning time.
